(19) United States
(12) Patent Application Publication
(10) Pub. No.: US 2012/0286009 A1
(43) Pub. Date: Nov. 15, 2012

(54) VARIABLE FUEL CONTAINER STORAGE AND TRANSPORT CARRIER

(75) Inventors: Charlie L. Forbis, Quapaw, OK (US); Harvey A. Moyer, Loma Linda, MO (US)

(73) Assignee: BLITZ U.S.A., INC., Miami, OK (US)

(21) Appl. No.: 13/103,312

(22) Filed: May 9, 2011

(51) Int. Cl. B60R 11/00; B65D 25/00

(52) U.S. Cl. 224/400; 220/737

(57) ABSTRACT

A storage and transport carrier is configured to securely hold a selected one or more of a plurality of differently-shaped fuel containers therein. The carrier includes a unitary molded body with first and second pairs of opposite side walls. The body also includes a bottom wall that extends generally between the side walls, such that surfaces of the side walls and the bottom wall cooperatively define an interior chamber of the body. The body also includes a pair of opposite elongated protrusions. Each protrusion projects upwardly from the bottom wall and is spaced laterally inwardly from a respective one of the second pair of side walls. Each of the elongated protrusions extends between opposite end margins and presents an inner container-engaging surface. The inner container-engaging surfaces are configured to engage at least a portion of one or more of the fuel containers, and thereby securely retain the same, when the containers are selectively disposed within the interior chamber of the body.

### BACKGROUND OF THE INVENTION

1. Field of the Invention

The present invention relates generally to a storage and transport carrier. More specifically, the present invention concerns a storage and transport carrier that is configured to securely hold multiple configurations of individual or combinations of fuel containers, including containers of different shapes and/or capacities.

2. Discussion of the Prior Art

Those of ordinary skill in the art will appreciate that liquid fuel is used to power many devices. Often, the liquid fuel is stored in and/or dispensed from a fuel container (e.g., gas cans, liquid propane cylinders, etc.). For a variety of reasons, it frequently becomes necessary to transport both empty and filled fuel containers.

One common arrangement for transporting fuel containers is to load the fuel container into a vehicle, such as the interior of a car or the bed of a truck. Traditionally, it has been difficult to keep a fuel container stable while it is being transported, and the dangers of transporting unstable fuel containers can be significant. A conventional arrangement involves using a dedicated carrier designed specifically to carry only one type of fuel container (e.g., a standard 20 lb liquid propane cylinder).

### SUMMARY

According to an aspect of the present invention, a unique storage and transport carrier may be used for securely holding a selected one or more of a plurality of fuel containers. From this inventive construction, multiple configurations of individual or combinations of fuel containers, including containers of different shapes and/or capacities, may be securely held by a single carrier without the need for moveable dividers or the like. Additionally, the novel carrier maintains stability of a held fuel container, which may prevent undesirable static buildup, and provides a contained overflow area in case any fuel is accidently spilled during transport. Multiple carriers can be vertically nested within one another for storage, and the carriers can be secured to one another side-by-side for transport of additional fuel containers.

According to one aspect of the present invention, a storage and transport carrier is provided that is configured to securely hold a selected one or more of a plurality of fuel containers. The carrier includes a unitary molded body. The body includes a side wall that presents opposite inner and outer surfaces. The body further includes a bottom wall that extends generally between the side wall, and the bottom wall presents opposite interior and exterior surfaces. The inner surface of the side wall and the interior surface of the bottom wall cooperatively define an interior chamber of the body. The body further includes a pair of opposite elongated protrusions, wherein each protrusion projects upwardly from the bottom wall and is spaced laterally inwardly from the side wall. Each of the elongated protrusions extends between opposite end margins and presents an inner container-engaging surface that is configured to engage at least a portion of one or more of the fuel containers when disposed within the interior chamber of the body.

This summary is provided to introduce a selection of concepts in a simplified form that are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is an isometric view (taken from generally above) of a storage and transport carrier constructed in accordance with the principles of a preferred embodiment of the present invention and configured to securely hold a selected one or more of a plurality of fuel containers, depicting interior engagement surfaces of a bottom wall, side walls, and a first protrusion;

FIG. 2 is an isometric view (taken from generally below) of the storage and transport carrier of FIG. 1, shown from another vantage point, depicting a central toothed ring of an exterior surface of the bottom wall and a plurality of non-slip feet disposed generally at corners of the carrier;

FIG. 3 is an isometric view (taken from generally above) of the storage and transport carrier of FIGS. 1 and 2, similar in many respects to FIG. 1, but shown from an angle generally opposite that shown in FIG. 1 (i.e., turned 180°), depicting interior engagement surfaces of the bottom wall, side walls, and a second protrusion disposed opposite the first protrusion;

FIG. 4 is an isometric view (taken from generally below) of the storage and transport carrier of FIGS. 1-3, similar in many respects to FIG. 2, but shown from the angle depicted in FIG. 3, depicting the central toothed ring of an exterior surface of the bottom wall and the plurality of non-slip feet disposed generally at corners of the carrier;

FIG. 5 is a partial fragmentary, top-down plan view of a pair of the storage and transport carriers of FIGS. 1-4, depicting the pair of carriers being secured to one another;

FIG. 6 is a generally isometric, sectional view of a portion of one of the storage and transport carriers of FIGS. 1-5, taken along the line 6-6 of FIG. 5, depicting in detail the wall structure of the molded carrier body;

FIG. 7 is a side elevation, sectional view of a pair of the storage and transport carriers of FIGS. 1-6, depicting the pair of carriers being stacked on one another in a nested configuration;

FIG. 8 is a generally isometric, partial sectional view of a portion of the pair of storage and transport carriers of FIG. 5, taken along the line 8-8 of FIG. 5, depicting in detail the wall structure of the carrier bodies and a tab-and-slot arrangement securing the pair of carriers to one another;

FIG. 9 is an isometric, somewhat exploded view of a plurality of the storage and transport carriers of FIGS. 1-8, depicting the plurality of carriers being disposed for securement to each other;

FIG. 10 is an isometric view of the plurality of the storage and transport carriers of FIG. 9, depicting the plurality of carriers being secured to one another;

FIG. 11 is an isometric view of the storage and transport carrier of FIGS. 1-4, shown with a standard liquid propane cylinder disposed therein, with the propane cylinder being secured to the carrier with bungee cords;

FIG. 11a is a top-down plan view of the storage and transport carrier with the propane cylinder secured therein of FIG. 11, particularly depicting engagement between the propane cylinder and portions of the protrusions;

FIG. 12 is an isometric view of the storage and transport carrier of FIGS. 1-4, shown with a single large fuel container disposed therein, with the fuel container being secured to the carrier with a bungee cord;

FIG. 12a is a top-down plan view of the storage and transport carrier with the single large fuel container secured therein of FIG. 12, particularly depicting engagement between the fuel container and portions of the protrusions;

FIG. 13 is an isometric view of the storage and transport carrier of FIGS. 1-4, shown with a pair of medium fuel containers disposed therein, with the fuel containers being secured to the carrier with a bungee cord;

FIG. 13a is a top-down plan view of the storage and transport carrier with the pair of medium fuel containers secured therein of FIG. 13, particularly depicting engagement between the fuel containers and portions of the protrusions;

FIG. 14 is an isometric view of the storage and transport carrier of FIGS. 1-4, shown with one medium fuel container and one small fuel container disposed therein, with each of the fuel containers being secured to the carrier with a bungee cord;

FIG. 14a is a top-down plan view of the storage and transport carrier with one medium fuel container and one small fuel container secured therein of FIG. 14, particularly depicting engagement between the fuel containers and portions of the protrusions;

FIG. 15 is an isometric view of the storage and transport carrier of FIGS. 1-4, shown with a pair of small fuel containers disposed therein, with the fuel containers being secured to the carrier with bungee cords; and

FIG. 15a is a top-down plan view of the storage and transport carrier with the pair of small fuel containers secured therein of FIG. 15, particularly depicting engagement between the fuel containers and portions of the protrusions.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

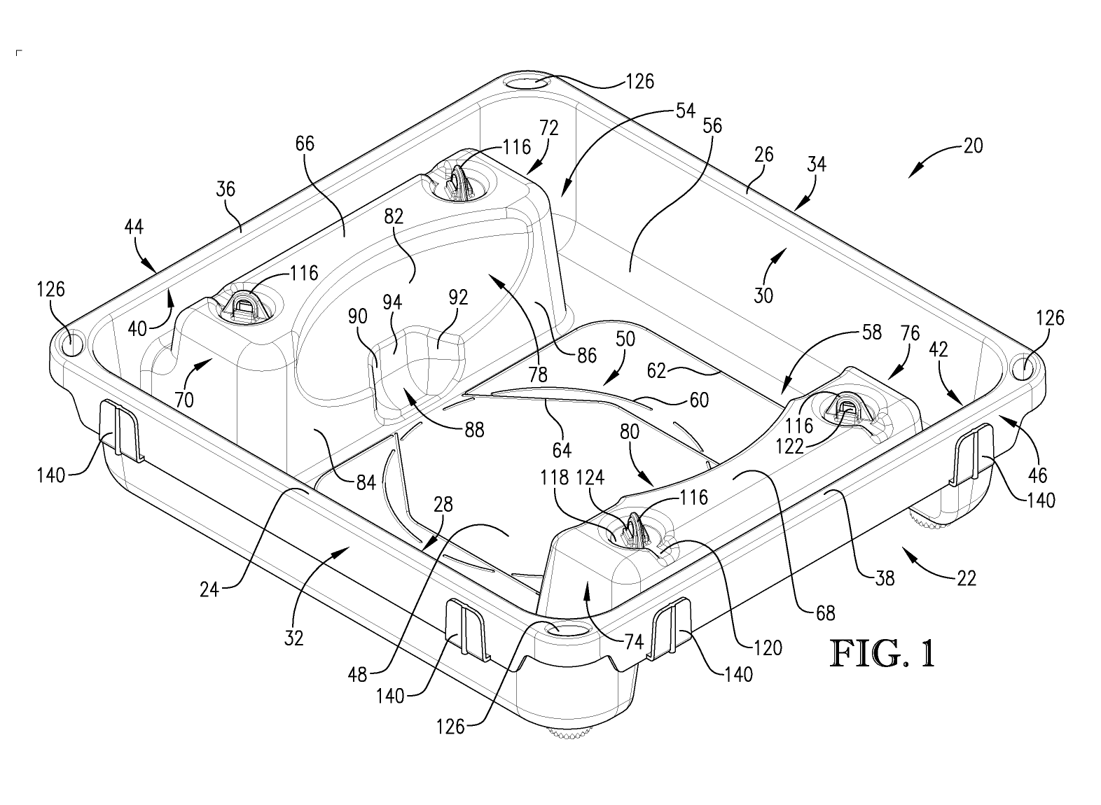

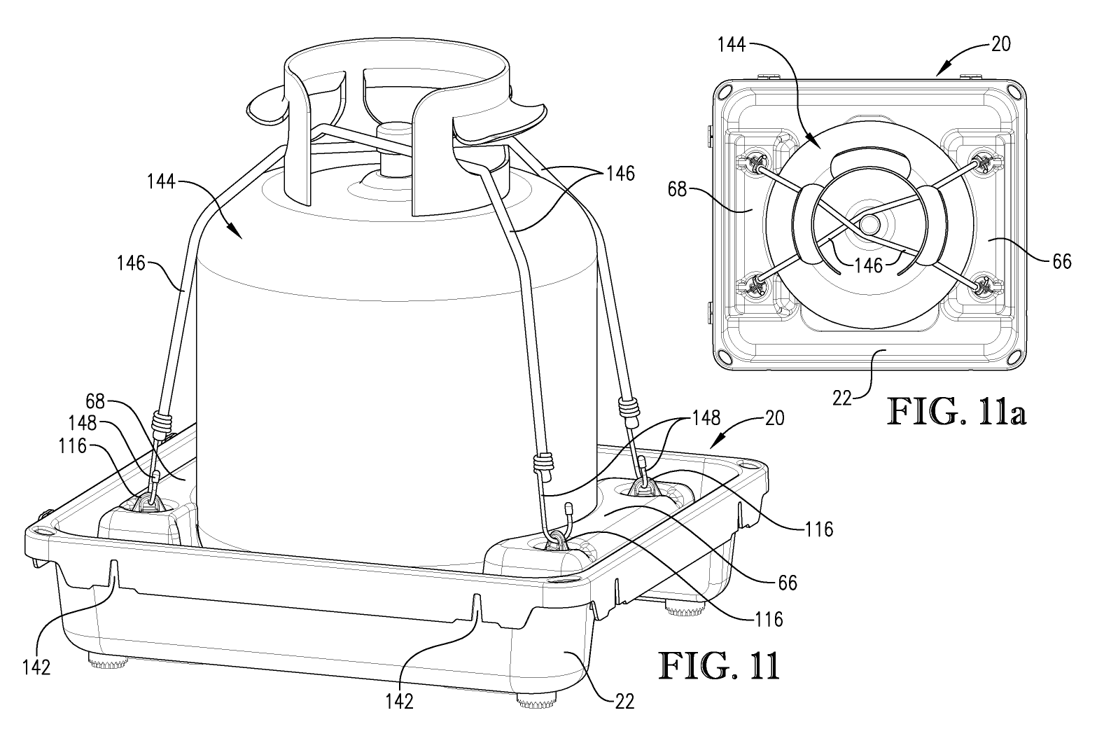

With initial reference to FIGS. 1-4, a storage and transport carrier 20 constructed in accordance with a preferred embodiment of the present invention is depicted for use in various applications. The carrier 20 is configured to securely hold a selected one or more of a plurality of fuel containers (see, e.g., FIGS. 11-15 discussed below). The carrier 20 broadly includes a unitary molded body 22.

It is noted at the outset that many of the structural features discussed below cooperate to provide the body 22 of the carrier 20 with a strong and durable unitary construction without requiring excess material thickness. This construction enables the carrier 20 to be formed from a relatively lightweight material that can be cost-effectively mass-produced without comprising the strength and durability of the carrier 20. For example, the depicted carrier 20 can be formed from a synthetic resin material, such as injected molded plastic, preferably polypropylene or polyethylene. In this manner, the carrier 20 is strong, lightweight, readily transportable, and easy to store. While this unitary, molded plastic construction is preferred, it is clearly within the ambit of the present invention to form the carrier 20 from virtually any material, including materials other than plastic, or in virtually any other manner, including constructions other than the depicted configuration.

The body 22 includes a first pair of opposite side walls 24, 26. Each of the first side walls 24, 26 presents an inner surface 28, 30 and an opposite outer surface 32, 34. The body 22 also includes a second pair of opposite side walls 36, 38. Each of the second side walls 36, 38 presents an inner surface 40, 42 and an opposite outer surface 44, 46. Although the depicted side walls 24, 26, 36, 38 cause the illustrated carrier 20 to have a generally rectangular shape, it will be appreciated that the body 22 may alternatively be formed in different polygonal or non-polygonal shapes without departing from the spirit of the present invention.

The body 22 further includes a bottom wall 48 that extends generally between the side walls 24, 26, 36, 38. The bottom wall 48 presents an interior surface 50 and an opposite exterior surface 52.

The body 22 presents an interior chamber 54. The interior chamber 54 is cooperatively defined by the inner surfaces 28, 30, 40, 42 of the side walls 24, 26, 36, 38 and the interior surface 50 of the bottom wall 48.

The side walls 24, 26, 36, 38 and the bottom wall 48 intersect one another substantially continuously about an outer periphery 56 of the bottom wall 48. In this way, the side walls 24, 26, 36, 38 and the bottom wall 48 cooperatively form a drip trough 58 within the interior chamber 54 of the body 22. The drip trough 58 will retain material (e.g., liquid fuel) that may leak or spill out from one or more of the fuel containers received within the carrier 20. As will be readily appreciated by one of ordinary skill in the art, the drip trough 58 ensures that any undesirable material remains within the confines of the body 22 and does not leak out onto other surfaces, such as the interior of a transport vehicle.

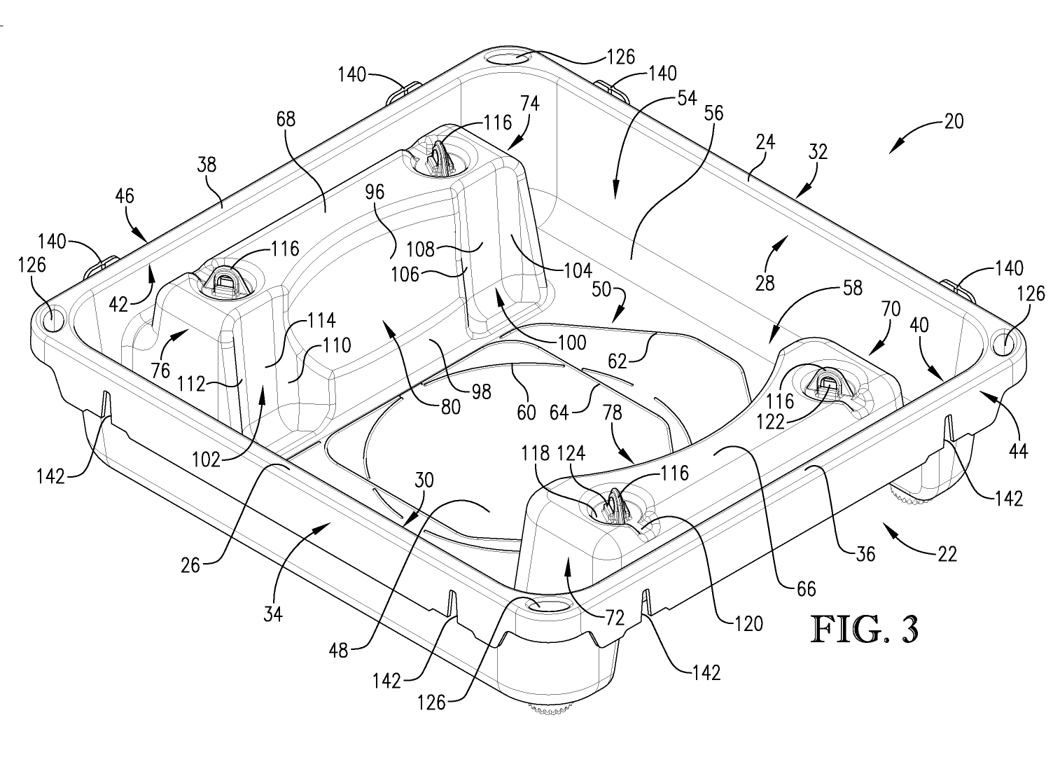

With attention specifically now to FIGS. 1 and 3, the interior surface 50 of the bottom wall 48 includes a plurality of generally upwardly protruding guide ridges 60, 62, 64. As will be readily apparent to one of ordinary skill in the art from a review of FIGS. 11-15, the guide ridges 60, 62, 64 are configured to indicate sample dispositions for selected ones of the fuel containers (such as the illustrative examples shown in FIGS. 11-15) to be received within the interior chamber 54 of the body 22.

With continued reference now to FIGS. 1-4, the body 22 also includes a pair of opposite elongated protrusions 66, 68. Each elongated protrusion 66, 68 projects generally upwardly from the bottom wall 48, such that the protrusions 66, 68 are disposed within the interior chamber 54 of the body 22. In the illustrated embodiment, each elongated protrusion 66, 68 is spaced laterally inwardly from a respective one of the second side walls 36, 38. In more detail, the first protrusion 66 is spaced laterally inwardly from the second side wall 36 and the second protrusion 68 is spaced laterally inwardly from the second side wall 38.

Each of the elongated protrusions 66, 68 extends between a pair of opposite end margins 70, 72, 74, 76. In more detail, the first protrusion 66 extends between opposite end margins 70, 72 and the second protrusion 68 extends between opposite end margins 74, 76. As shown in the illustrated embodiment, each of the elongated protrusions 66, 68 extends generally parallel to one of the respective second side walls 36, 38. The protrusions 66, 68 are shorter than the second side walls 36, 38, such that the end margins 70, 72, 74, 76 are disposed within the interior chamber 54 of the body 22. Furthermore each of the end margins 70, 72, 74, 76 is spaced laterally inwardly from a respective one of the first side walls 24, 26.

Each of the elongated protrusions 66, 68 presents an inner container-engaging surface 78, 80 that is configured to engage at least a portion of one or more of the fuel containers when the container is disposed within the interior chamber 54 of the body 22 (as shown in the illustrative examples of FIGS. 11-15). In the depicted embodiment, each of the inner container-engaging surfaces 78, 80 includes a plurality of structural portions that are uniquely configured to selectively engage portions of differently-shaped fuel containers. These structural portions of the inner container-engaging surfaces 78, 80 will now be described in detail.

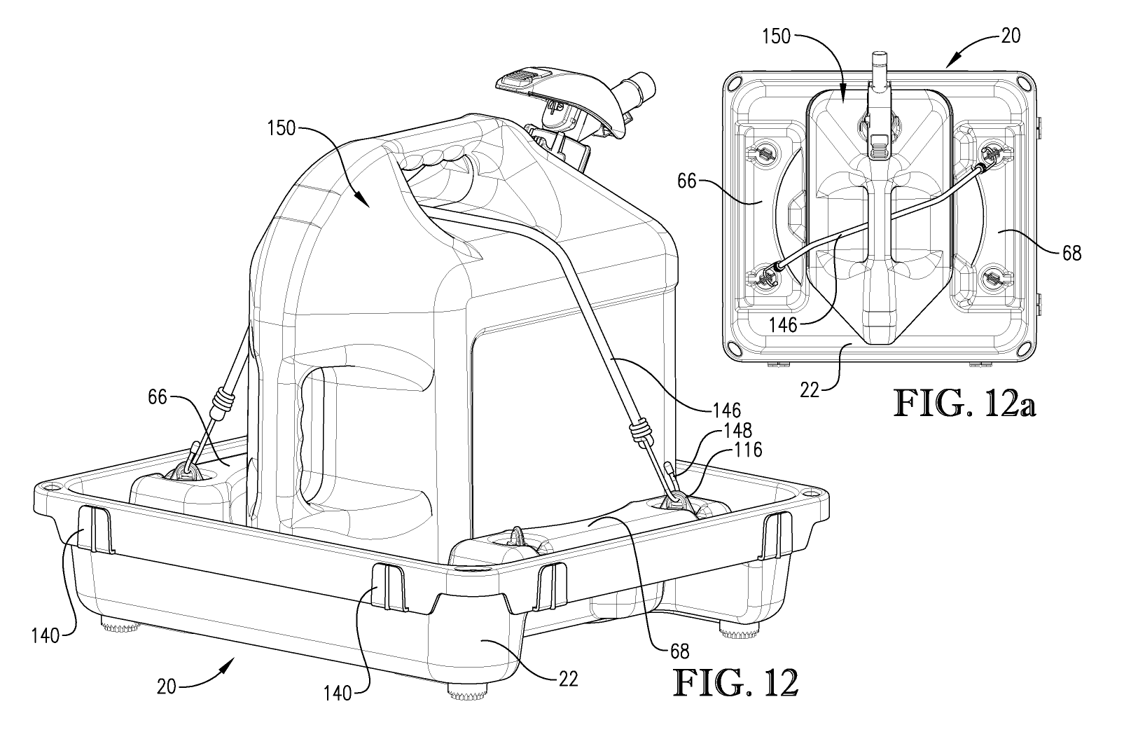

With attention initially to the first elongated protrusion 66 (shown particularly in FIG. 1), the inner container-engaging surface 78 thereof includes a concave arcuate portion 82 that is configured to selectively engage part of one of the containers (see, e.g., FIG. 11). The inner container-engaging surface 78 of the first protrusion 66 further includes flat face portions 84, 86 that are configured to selectively engage part of another one or more of the containers (see, e.g., FIGS. 12-15).

The interior container-engaging surface 78 of the first protrusion 66 further includes a vertically extending tapered notch 88 defined therein that is configured to selectively engage part of another one of the containers (not shown). The tapered notch 88 is disposed generally centrally between the end margins 70, 72 of the first elongated protrusion 66.

In more detail, the tapered notch 88 includes a pair of tapering side walls 90, 92 and a generally flat back wall 94. As will be readily understood by one of ordinary skill in the art upon review of this disclosure, the depicted shape of the notch 88 is configured to correspond with a part of selected fuel containers, but could be alternatively configured to correspond with parts of other fuel container shapes (not shown).

Turning now to the second elongated protrusion 68 (shown particularly in FIG. 3), the inner container-engaging surface 80 thereof includes a concave arcuate portion 96 that is configured to selectively engage part of one of the containers (see, e.g., FIG. 11). The inner container-engaging surface 80 of the second protrusion 68 further includes a flat face portion 98 that is configured to selectively engage part of another one or more of the containers (see, e.g., FIGS. 12-15).

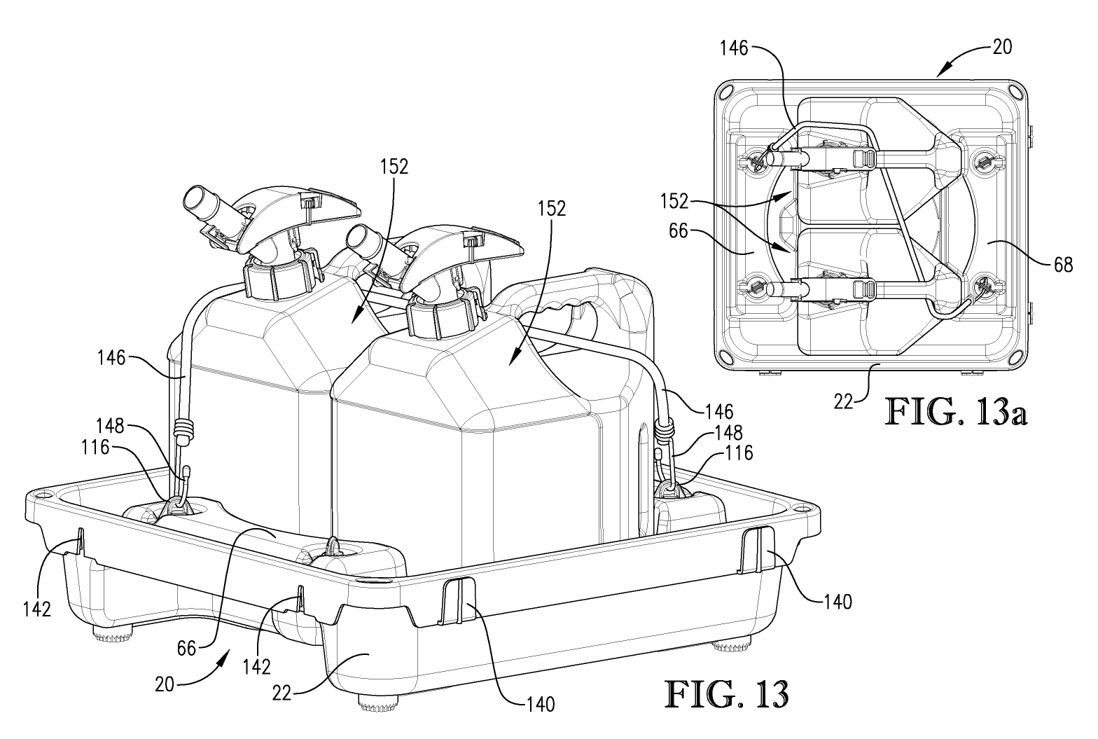

The interior container-engaging surface 80 of the second protrusion 68 further includes a pair of vertically extending tapered notches 100, 102 defined therein, with each notch 100, 102 being configured to selectively engage part of another one of the containers (see, e.g., FIGS. 13-15). Each of the tapered notches 100, 102 is disposed generally adjacent a respective one of the end margins 74, 76 of the second elongated protrusion 68 (and also generally adjacent the concave arcuate portion 96, which is disposed therebetween).

In more detail, the tapered notch 100 includes a pair of tapering side walls 104, 106 and a generally flat back wall 108. Similarly, the tapered notch 102 includes a pair of tapering side walls 110, 112 and a generally flat back wall 114. As will be readily understood by one of ordinary skill in the art upon review of this disclosure, the depicted shapes of the notches 100, 102 are configured to correspond with parts of selected fuel containers, but could be alternatively configured to correspond with parts of other fuel container shapes (not shown).

With continued reference to FIGS. 1 and 3 (and also to FIGS. 11-15), it will be readily appreciated that the arcuate portion 82 of the inner container-engaging surface 78 is disposed generally opposite the arcuate portion 96 of the inner container-engaging surface 80. Additionally, it will be readily appreciated that at least sections of the flat face portions 84, 86 of the inner container-engaging surface 78 are disposed generally opposite at least sections of the flat face portion 98 of the inner container-engaging surface 80.

Moreover, the notch 88 within the inner container-engaging surface 78 is disposed generally opposite at least a section of the flat face portion 98 of the inner container-engaging surface 80. Also, the notch 100 within the inner container-engaging surface 80 is disposed generally opposite at least a section of the flat face portion 84 of the inner container-engaging surface 78. Similarly, the notch 102 within the inner container-engaging surface 80 is disposed generally opposite at least a section of the flat face portion 86 of the inner container-engaging surface 78.

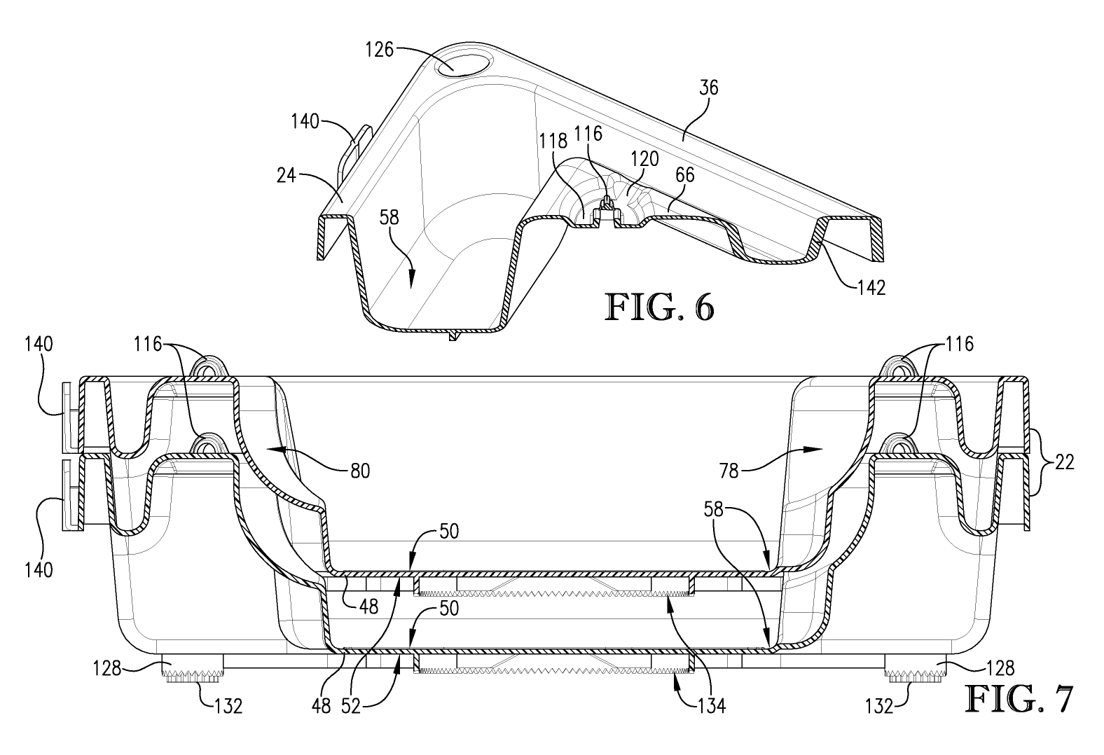

With attention still to FIGS. 1 and 3 (and also to FIGS. 6 and 11-15), each of the elongated protrusions 66, 68 define a pair of laterally spaced apart hook-receiving loops 116. The hook-receiving loops 116 are configured to receive therethrough a hook of a connecting element (e.g., a bungee cord; see FIGS. 11-15) that is operable to secure one or more of the fuel containers within the interior chamber 54 of the body 22. In more detail, each of the illustrated hook-receiving loops 116 extends generally upwardly and is disposed generally adjacent a respective one of the end margins 70, 72, 74, 76 of the elongated protrusions 66, 68, although other configuration or placement of alternative hook-receiving loops (not shown) would remain firmly within the ambit of the present invention.

In even more detail, each of the depicted hook-receiving loops 116 is disposed within (and extends generally upwardly from) a circular recessed liquid containment area 118. Each recessed liquid containment area 118 is in communication with a drainage pathway 120, such that any stray liquid that may enter the liquid containment area 118 (such as fuel leaks or spills) drains away from the hook-receiving loops 116 and into the drip trough 58. In the illustrated embodiment, a hole 122 defined by the hook-receiving loop 116 is disposed above a raised portion 124, such that any stray liquid is directed away from the hole 122, as will be readily appreciated by one of ordinary skill in the art upon review of this disclosure.

Turning briefly now to FIGS. 1-4, the body 22 of the carrier 20 defines therethrough a plurality of securing holes 126. As will be readily understood by one of ordinary skill in the art, each securing hole 126 is configured to receive a securing element (e.g., a tie rope; not shown) for securing the body 22 within a transport vehicle. In the illustrated embodiment, the body 22 defines four securing holes 126, with each hole 126 being defined in a corner of the illustrated body 22 formed by intersecting adjacent side walls 22, 26, 36, 38.

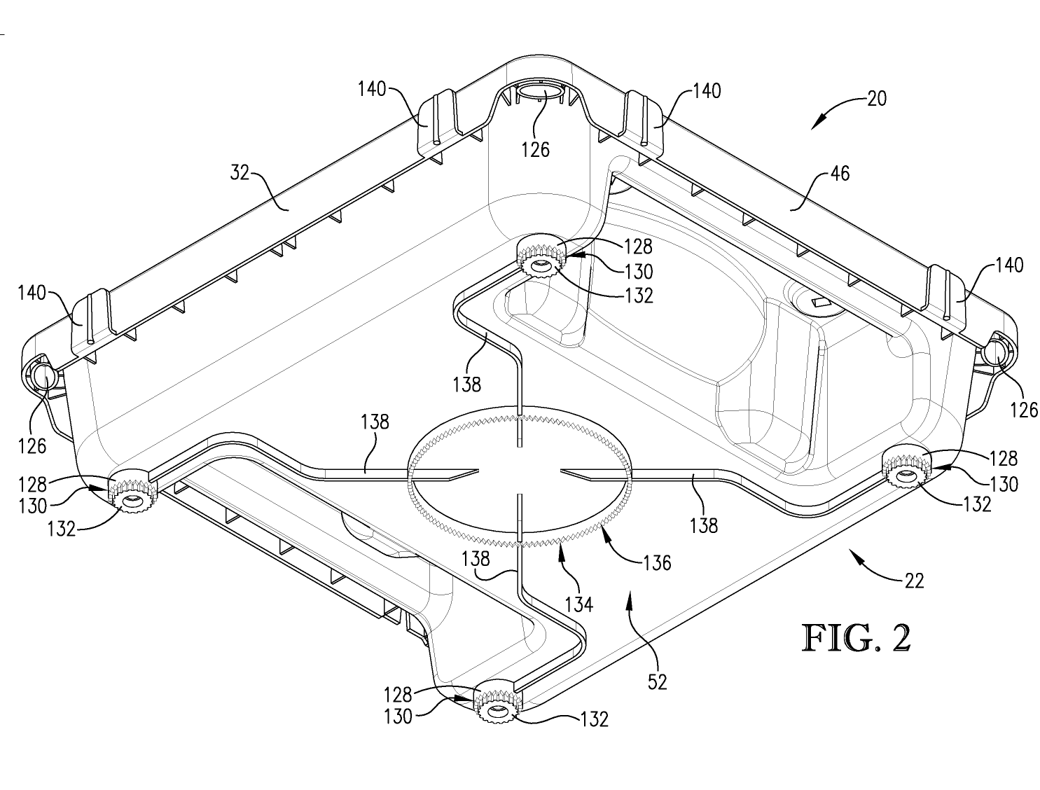

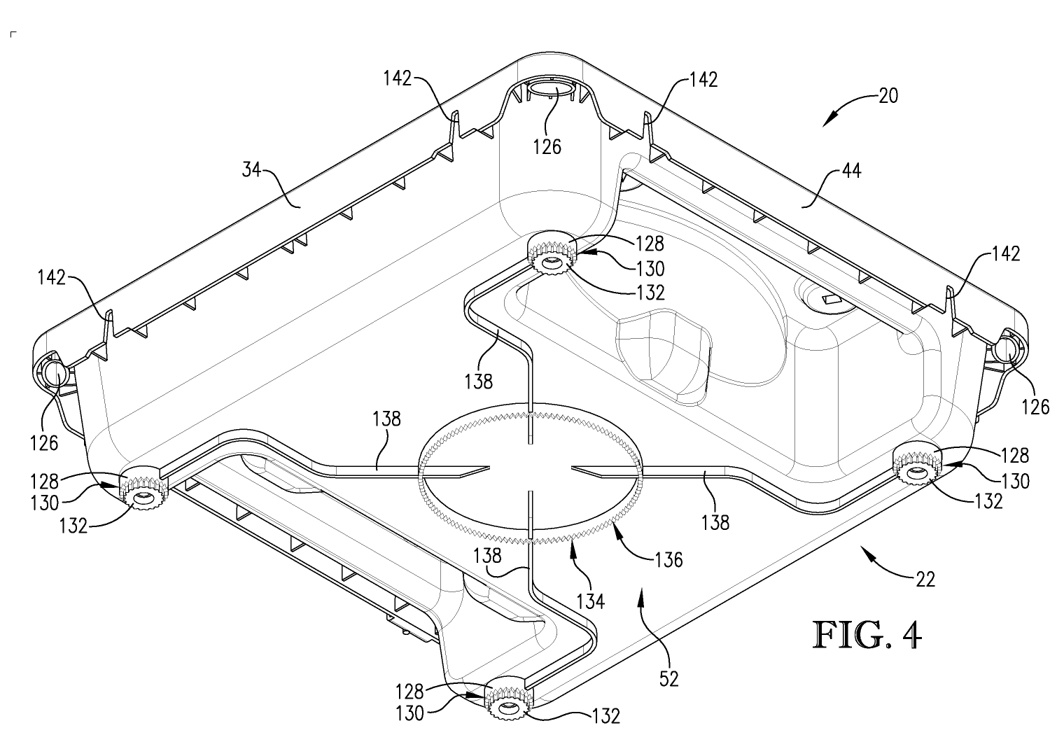

Looking particularly now to FIGS. 2 and 4, the body 22 of the carrier 20 includes a plurality of molded feet 128, with each molded foot 128 extending generally downwardly from the exterior surface 52 of the bottom wall 48. In the illustrated embodiment, the body 22 includes four molded feet 128, with each foot 128 being generally disposed in a corner of the bottom wall 48.

In more detail, each foot 128 is generally annular in shape and includes a plurality of teeth 130 arranged around a lower margin thereof. It is believed that the teeth 130 may assist in preventing the body 22 from sliding on some transport surfaces (e.g., carpet in an automobile).

In the illustrated embodiment, each foot 128 also includes a selectively removable non-slip polymer element 132 being received therein. It is believe that the non-slip polymer element 132 may assist in preventing the body 22 from sliding on some other transport surfaces (e.g., a truck bed).

The depicted body 22 also includes a generally centrally disposed ring 134 that extends downwardly from the exterior surface 52 of the bottom wall 48. The ring 134 includes a plurality of teeth 136 configured to frictionally engage a selected transporting or storage surface (e.g., carpet) to thereby reduce slipping between the body 22 and the transporting or storage surface. As will be readily appreciated by one of ordinary skill in the art upon review of this disclosure, when the non-slip polymer elements 132 are received within the feet 128, the body 22 may be elevated sufficiently above the transporting or storage surface such that the toothed ring 134 does not contact the transporting or storage surface. In the illustrated embodiment, a plurality of structural ribs 138 are shown extending generally from each of the feet 128 toward and into the toothed ring 134.

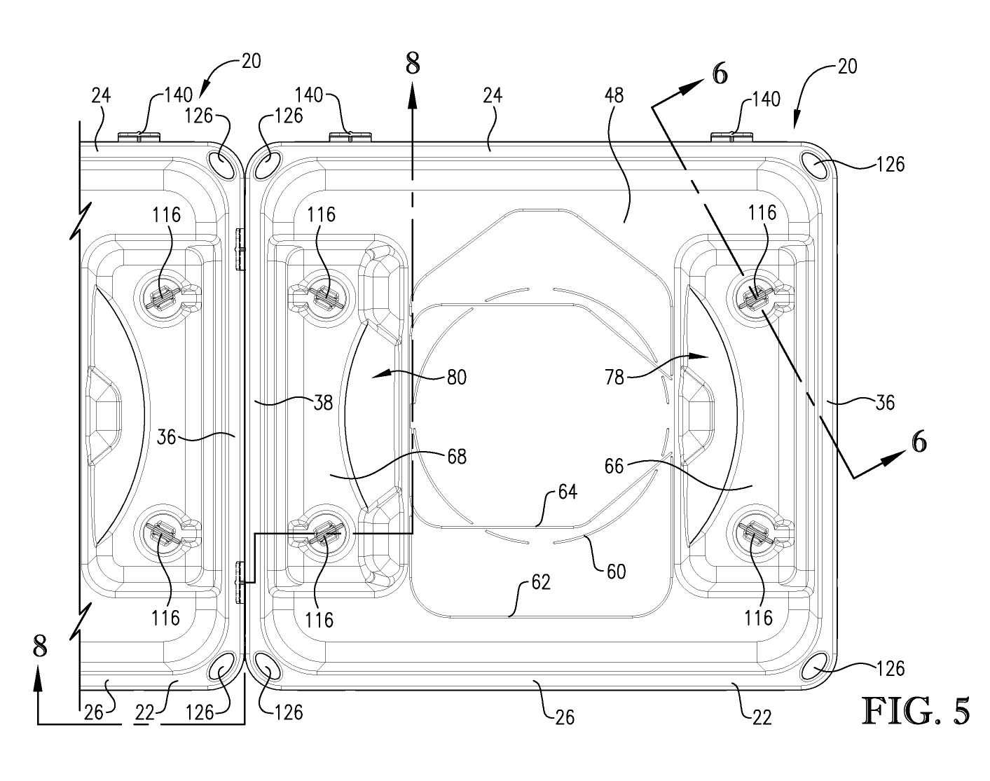

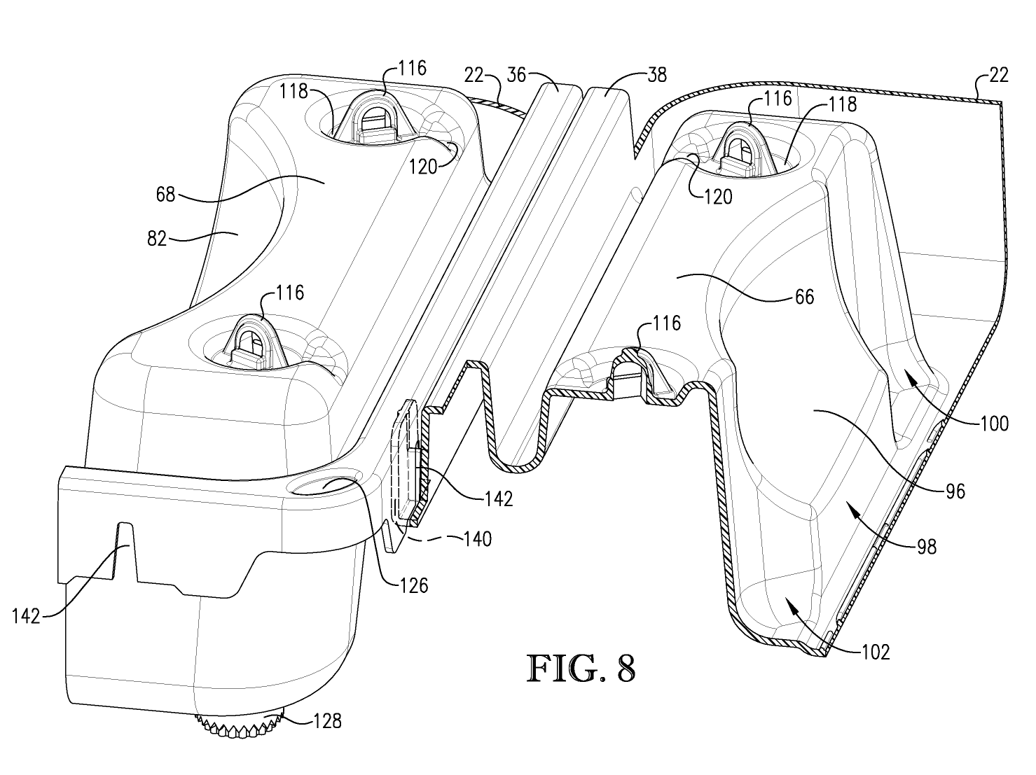

With continued reference to FIGS. 1-4, and with particular attention also to FIGS. 5 and 8-10, it will be understood by one of ordinary skill in the art that the body 22 includes a pair of spaced apart connection tabs 140 extending generally outwardly from each of the adjacent side walls 24, 38. In more detail, each connection tab 140 extends generally outwardly from the respective outer surface 32, 46 of the side walls 24, 38.

Additionally, the body 22 includes a corresponding pair of spaced apart connection slots 142 defined within each of the two other adjacent side walls 26, 36. In more detail, each connection slot 142 is defined within the respective outer surface 34, 44 of the side walls 26, 36. As will be readily appreciated by one of ordinary skill in the art upon review of this disclosure, each connection slot 142 is configured to receive a corresponding connection tab 140 of another identical carrier body 22 (see, e.g., FIGS. 5 and 8-10).

In more detail now regarding specifics of construction of the illustrated embodiment, and with particular attention to FIG. 5, it will be readily appreciated that opposite ones of the first pair of side walls 24, 26 and that opposite ones of the second pair of side walls 36, 38 present substantially equal length dimensions. In other words, the body 22 of the illustrated embodiment is generally rectangular, although other shapes for an alternative carrier (not shown) may fall within the ambit of the present invention.

In even more detail, the first pair of side walls 24, 26 is longer than the second pair of side walls 36, 38. In the illustrated embodiment, each of the first pair of side walls 24, 26 presents a length dimension along the outer surface 32, 34 thereof of approximately eighteen and one-half inches (18.5″). Also in the illustrated embodiment, each of the second pair of side walls 36, 38 presents a length dimension along the outer surface 44, 46 thereof of approximately seventeen inches (17″).

In addition to the lengths of the first and second side walls 24, 26 and 32, 34 being different from one another, it is also noted that the length spacing between each of the adjacent pairs of connection tabs 140 and connection slots 142 is may also be different from one another (although it will be readily appreciated that the spacing therebetween across opposite side walls is equal). In the illustrated embodiment, the length between the connection tabs 140 and the connection slots 142 along the first side walls 24, 26 is approximately twelve inches (12″). Also in the illustrated embodiment, the length between the connection tabs 140 and the connection slots 142 along the second side walls 32, 34 is approximately ten and one-half inches (10.5″).

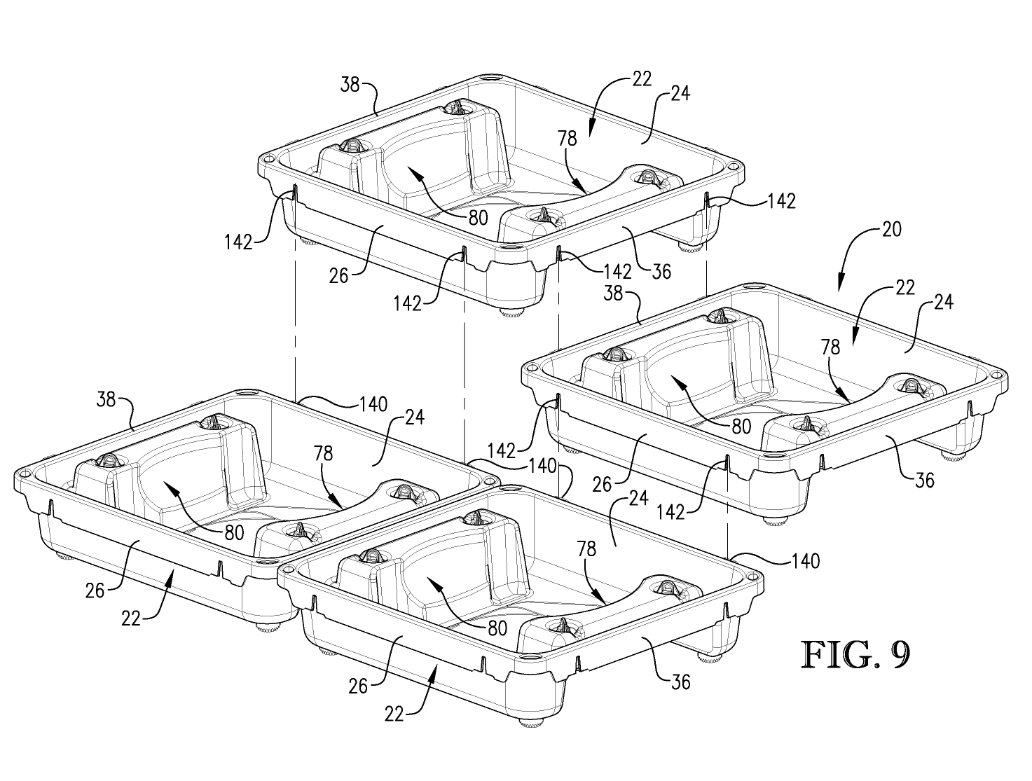

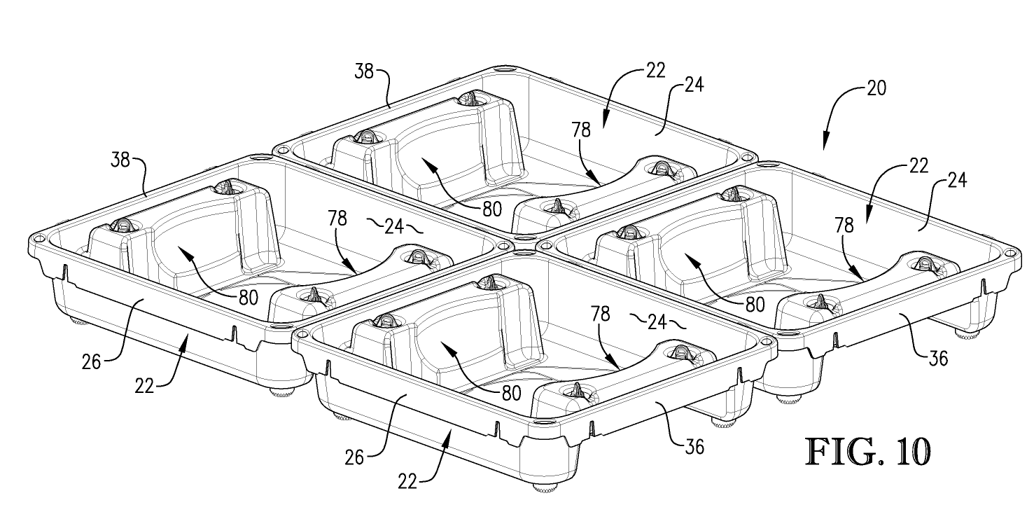

In this way, one of ordinary skill in the art will readily appreciate that a plurality of identical bodies 22 may be connected to one another along the first side walls 24, 26 (the long sides) to form a line, along the second side walls 32, 34 (the short sides) to form a line, or both (see, e.g., FIGS. 9 and 10) to form a grid. It is believed that the preferred dimensions disclosed in detail herein allows for a plurality of identical carrier bodies 22 to be selectively secured together to fit generally snugly within a standard truck bed.

With attention briefly now to FIG. 7, it will be readily appreciated that a plurality of identical carrier bodies 22 may also be nested with one another, such as for compact storage of multiple carriers 20. In more detail, the interior face 50 of the bottom wall 48 of one of the bodies 22 (the bottom carrier) is disposed below the exterior face 52 of the bottom wall 48 of another of the bodies 22 (the top carrier) and portions of the side walls 24, 26, 36, 38 of the respective bodies 22 overlap one another when the bodies 22 are nested.

Turning now specifically to the illustrative examples shown in FIGS. 11-15 of fuel containers being received within the interior chamber 54 of the body 22, the placement and securement of the various fuel containers within the carrier 20 should be apparent from the foregoing and, therefore, will be described here only briefly.

With attention to FIGS. 11 and 11a, a fuel container in the form of a liquid propane cylinder 144 is disposed within the interior chamber 54 of the carrier 20. A pair of connecting elements in the form of bungee cords 146, each having a pair of hooks 148, are secured to the body 22 (with the hooks 148 being received within the hook-receiving loops 116) and are wrapped around the liquid propane cylinder 144. As discussed above, the liquid propane cylinder 144 is disposed generally on the circular guide ridge 60. In this disposition, side parts of the liquid propane cylinder 144 engage the concave arcuate portions 82, 96 of the container-engaging surfaces 78, 80 to stabilize the liquid propane cylinder 144 within the carrier 20.

Looking now to FIGS. 12 and 12a, a large fuel container in the form of a five gallon gas can 150 is disposed within the chamber 54 of the carrier 20. A single connecting element in the form of bungee cord 146, having a pair of hooks 148, is secured to the body 22 (with the hooks 148 being received within the hook-receiving loops 116) and is wrapped around the five gallon gas can 150. As discussed above, the five gallon gas can 150 is disposed generally on the large polygonal guide ridge 62. In this disposition, side parts of the five gallon gas can 150 engage the flat face portions 84, 86, 98 of the container-engaging surfaces 78, 80 to stabilize the five gallon gas can 150 within the carrier 20.

FIGS. 13 and 13a depict a pair of medium fuel containers, each in the form of a two gallon gas can 152, being disposed within the chamber 54 of the carrier 20. A single connecting element in the form of bungee cord 146, having a pair of hooks 148, is secured to the body 22 (with the hooks 148 being received within the hook-receiving loops 116) and is wrapped around both of the two gallon gas cans 152. As discussed above, each of the two gallon gas cans 152 is disposed with a generally converging handle portion being received within one of the pair of notches 100, 102 of the container-engaging surface 80. Additionally, each of the two gallon gas cans 152 is disposed with a substantially flat front portion engaging the flat face portions 84, 86 of the container-engaging surface 78. In this way, both of the two gallon gas cans 152 are stabilized within the carrier 20.

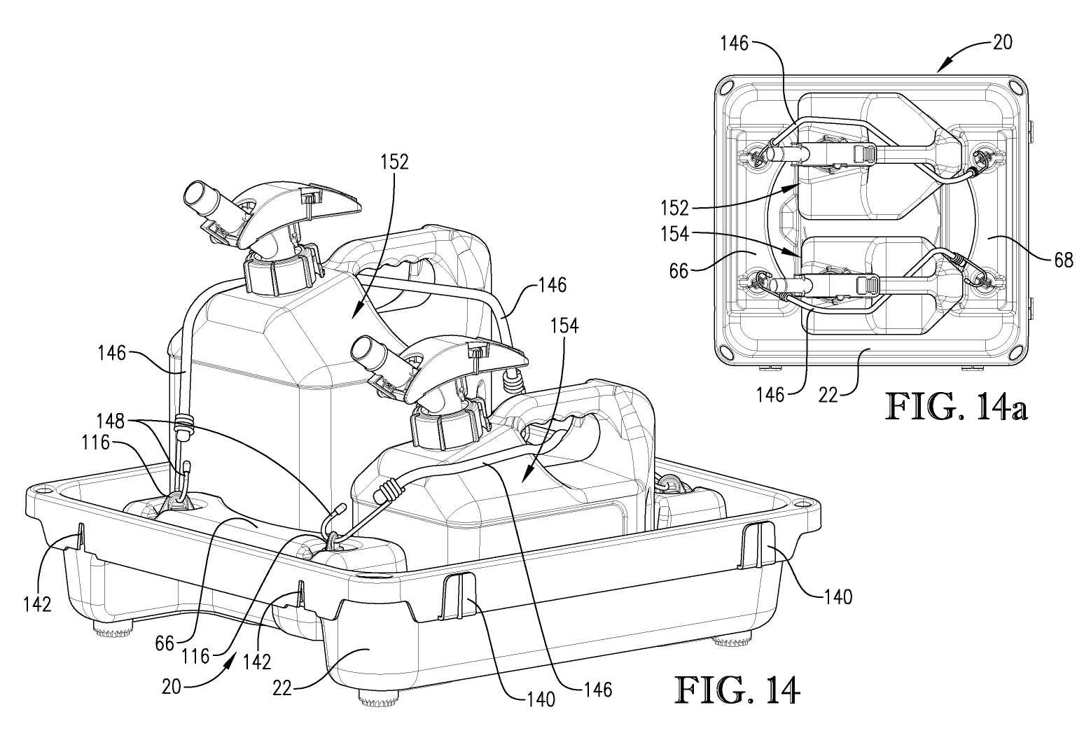

Next, FIGS. 14 and 14a illustrate a pair of fuel containers, one in the form of a medium two gallon gas can 152 and the other in the form of a small one gallon gas can 154, both being disposed within the chamber 54 of the carrier 20. A connecting element in the form of bungee cord 146, having a pair of hooks 148, is secured to the body 22 (with the hooks 148 being received within the hook-receiving loops 116) and is wrapped around each of the gas cans 152, 154. As discussed above, each of the gas cans 152, 154 is disposed with a generally converging handle portion being received within one of the pair of notches 100, 102 of the container-engaging surface 80. Additionally, each of the gas cans 152, 154 is disposed with a substantially flat front portion engaging the flat face portions 84, 86 of the container-engaging surface 78. In this way, both of the gas cans 152, 154 are stabilized within the carrier 20.

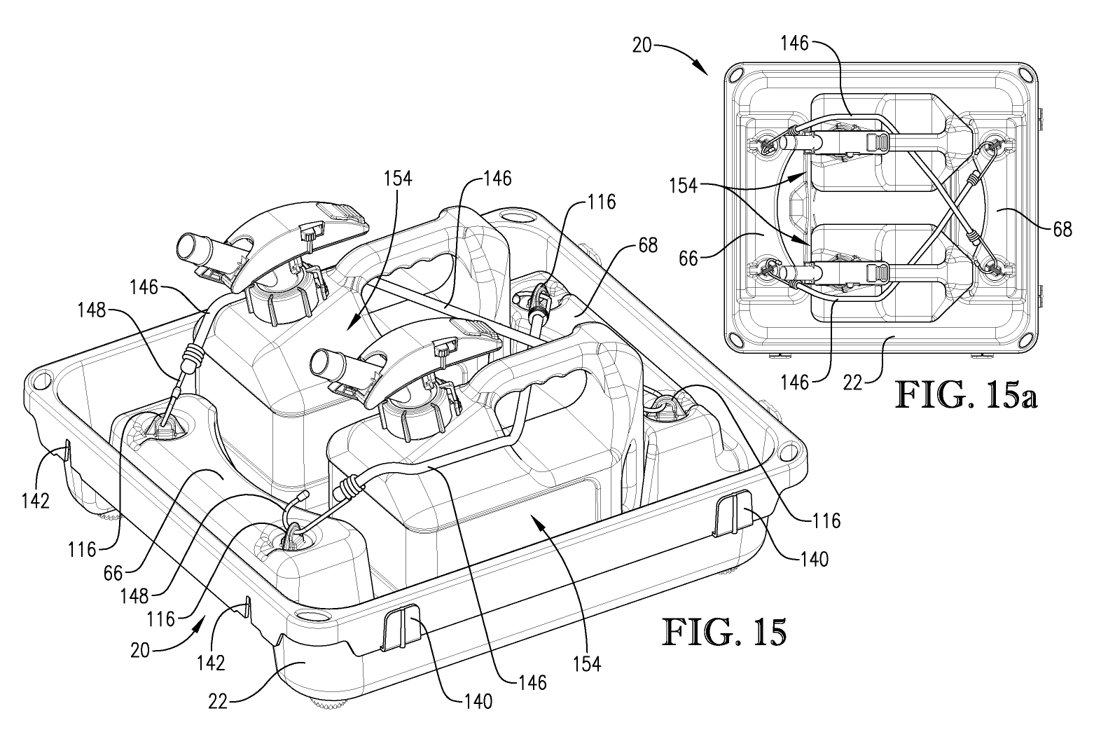

Finally, the example of FIGS. 15 and 15a shows a pair of small fuel containers, each in the form of a one gallon gas can 154, being disposed within the chamber 54 of the carrier 20. A pair of connecting elements in the form of bungee cords 146, each having a pair of hooks 148, are secured to the body 22 (with the hooks 148 being received within the hook-receiving loops 116) and are wrapped around both of the one gallon gas cans 154. As discussed above, each of the one gallon gas cans 154 is disposed with a generally converging handle portion being received within one of the pair of notches 100, 102 of the container-engaging surface 80. Additionally, each of the one gallon gas cans 154 is disposed with a substantially flat front portion engaging the flat face portions 84, 86 of the container-engaging surface 78. In this way, both of the one gallon gas cans 154 are stabilized within the carrier 20.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A storage and transport carrier configured to securely hold a selected one or more of a plurality of fuel containers, said carrier comprising:
a unitary molded body,
said body including a side wall presenting opposite inner and outer surfaces,
said body further including a bottom wall extending generally between the side wall, with the bottom wall presenting opposite interior and exterior surfaces,
said inner surface of the side wall and said interior surface of the bottom wall cooperatively defining an interior chamber of the body,
said body further including a pair of opposite elongated protrusions, with each protrusion projecting upwardly from the bottom wall and being spaced laterally inwardly from the side wall,
each of said elongated protrusions extending between opposite end margins and presenting an inner container-engaging surface configured to engage at least a portion of one or more of the fuel containers when disposed within the interior chamber of the body.

2. The storage and transport carrier as claimed in claim 1,
each of said inner container-engaging surfaces including a concave arcuate portion configured to engage part of a container, with the concave arcuate portions being disposed generally opposite one another.

3. The storage and transport carrier as claimed in claim 2,
each of said inner container-engaging surfaces further including a flat face portion configured to engage part of a container, with at least sections of the flat face portions being disposed generally opposite one another.

4. The storage and transport carrier as claimed in claim 3,
each of said inner container-engaging surfaces further including a vertically-extending tapered notch defined therein configured to engage part of a container, with the tapered notch being disposed generally opposite at least a section of the flat face portion of the opposite inner container-engaging surface.

5. The storage and transport carrier as claimed in claim 4,
one of said inner container-engaging surfaces including one tapered notch, with the notch being disposed generally centrally between the end margins of the elongated protrusion,
the other of said inner container-engaging surfaces including a pair of spaced apart tapered notches, with each notch of said pair of notches being disposed generally adjacent a respective one of the end margins of the elongated protrusion.

6. The storage and transport carrier as claimed in claim 1,
each of said elongated protrusions defining at least one hook-receiving loop configured to receive therethrough a hook of a connecting element.

7. The storage and transport carrier as claimed in claim 6,
each of said elongated protrusions defining a pair of laterally spaced apart hook-receiving loops, with each loop extending generally upwardly and being disposed generally adjacent a respective one of the end margins of the elongated protrusion.

8. The storage and transport carrier as claimed in claim 1,
said body defining therethrough at least one securing hole configured to receive a securing element for securing the body within a transport vehicle.

9. The storage and transport carrier as claimed in claim 8,
said body further including a first pair of opposite side walls and a second pair of opposite side walls, with each of the side walls presenting portions of the opposite inner and outer surfaces,
each protrusion being spaced laterally inwardly from a respective one of the second pair of side walls,
said body defining therethrough four securing holes, with each hole being defined in a corner of the body formed by intersecting adjacent side walls.

10. The storage and transport carrier as claimed in claim 1,
said body including at least one molded foot extending generally downwardly from the exterior surface of the bottom wall.

11. The storage and transport carrier as claimed in claim 10,
said body further including a first pair of opposite side walls and a second pair of opposite side walls, with each of the side walls presenting portions of the opposite inner and outer surfaces,
each protrusion being spaced laterally inwardly from a respective one of the second pair of side walls,
said body including four molded feet, with each foot being generally disposed in a corner of the bottom wall,
each of said feet including a selectively removable non-slip polymer element.

12. The storage and transport carrier as claimed in claim 1,
said body including a generally centrally-disposed ring extending downwardly from the exterior surface of the bottom wall,
said ring including a plurality of teeth configured to frictionally engage a transporting surface to thereby reduce slipping between the body and the transporting surface.

13. The storage and transport carrier as claimed in claim 1,
said body further including a first pair of opposite side walls and a second pair of opposite side walls, with each of the side walls presenting portions of the opposite inner and outer surfaces,
each protrusion being spaced laterally inwardly from a respective one of the second pair of side walls,
said body including at least one connection tab extending generally outwardly from the outer surface of one of the side walls,
said body further including at least one connection slot defined within the outer surface of another one of the side walls, with the connection slot being configured to receive a corresponding connection tab of another identical carrier body.

14. The storage and transport carrier as claimed in claim 13,
said body including a pair of spaced apart connection tabs extending generally outwardly from each of two adjacent side walls,
said body further including a pair of spaced apart connection slots defined within the outer surfaces of two other adjacent side walls.

15. The storage and transport carrier as claimed in claim 14,
opposite ones of the side walls presenting substantially equal length dimensions, such that the body is generally rectangular.

16. The storage and transport carrier as claimed in claim 15,
said first pair of side walls being longer than said second pair of side walls,
said pair of spaced apart connection tabs and said pair of spaced apart connection slots of respective opposed side walls each presenting a respective length dimension therebetween, with the length dimensions being substantially equal to one another.

17. The storage and transport carrier as claimed in claim 16,
each of said first pair of side walls presenting a length dimension along the outer surface thereof of approximately eighteen and one-half inches, and each of said second pair of side walls presenting a length dimension along the outer surface thereof of approximately seventeen inches.

18. The storage and transport carrier as claimed in claim 1,
said side wall and said bottom wall intersecting one another substantially continuously about the outer periphery of the bottom wall, such that the side wall and the bottom wall cooperatively form a drip trough within the internal chamber of the body to retain any material spilled from one or more of the fuel containers received therein.

19. The storage and transport carrier as claimed in claim 1,
said interior surface of the bottom wall including a plurality of generally upwardly protruding guide ridges configured to indicate sample disposition for selected ones of the fuel containers to be received within the interior chamber of the body.

20. The storage and transport carrier as claimed in claim 1,
said body being nestable with another identical carrier body, such that the interior face of the bottom wall of one of the bodies is disposed below the exterior face of the bottom wall of the other of the bodies and portions of the side walls of the respective bodies overlap one another when the bodies are nested.

21. The storage and transport carrier as claimed in claim 1,
said body further including a first pair of opposite side walls and a second pair of opposite side walls, with each of the side walls presenting portions of the opposite inner and outer surfaces,
each protrusion being spaced laterally inwardly from a respective one of the second pair of side walls.

22. The storage and transport carrier as claimed in claim 1,
said body being formed of a synthetic resin material.
